(19) United States
(12) Patent Application Publication
(10) Pub. No.: US 2026/0242058 A1
(43) Pub. Date: Aug. 20, 2026

(54) VERTICAL TAKE-OFF AND LANDING AIRCRAFT AND PROPULSION ASSEMBLY

(71) Applicant: Burl Aerospace Pty Ltd, Mount Gravatt East, Queensland (AU)

(72) Inventor: Pauline POUNDS, Queensland (AU)

(21) Appl. No.: 19/160,466

(22) PCT Filed: Feb. 28, 2024
(86) PCT No.: PCT/AU2024/050163

§ 371 Date: Aug. 28, 2025

(30) Foreign Application Priority Data
Feb. 28, 2023 (AU) 2023900522

(51) Int. Cl. B64C 27/16; B64C 25/32; B64C 27/06; B64C 27/50; B64C 27/82; B64D 3/00

(52) U.S. Cl. CPC B64C 27/16; B64C 25/405; B64C 27/06; B64C 27/50; B64C 27/82; B64D 3/00; B64C 2027/8218; B64C 2027/8227

(57) ABSTRACT

A vertical take-off and landing aircraft including a propulsion assembly adapted to lift a load is disclosed. The propulsion assembly can include a primary lift surface to provide sufficient lift to lift the load when rotating about a central axis. The propulsion assembly can include a secondary lift surface to provide lift along a second axis for lifting the propulsion assembly. The secondary lift surface can be configurable to induce rotation of the primary lift surface.

### RELATED APPLICATIONS

This is a national stage under 35 U.S.C. § 371 of International Application No. PCT/AU 2024/050163, filed Feb. 28, 2024, which claims convention priority from Australian Provisional Patent Application No. 2023900522, filed Feb. 28, 2023, the contents of which are incorporated herein in their entirety by reference thereto.

### TECHNICAL FIELD

The present invention relates to a vertical take-off and landing (VTOL) aircraft, and a propulsion assembly.

### BACKGROUND OF INVENTION

A problem in designing VTOL aircraft for a variety of civil and military uses is that while it is preferable for the required clearance area for landing an aircraft to be as small as possible, there is a trade-off between the size of a lifting system and the power required to produce thrust. An arbitrarily small thruster will require arbitrarily large power. The limited power density and energy density of aircraft power systems and power storage systems place a practical limit on how compact lifting systems can be for a given payload.

A further problem exists in that even if the surface-level clearance might be sufficient, obstacles such as trees and power lines may protrude into the vertical clearance required for take-off.

Existing approaches to minimizing the size of lifting systems necessarily sacrifice efficiency, either by the size of the system itself, or by selecting size-for-size more efficient lifting systems that can however realistically only be embodied in smaller form factors, such as ducted fans. Additionally, the clearance area for landing a VTOL aircraft is not solely defined by the size of the lifting system, but also the immediate downwash produced even by relatively efficient smaller lifting systems with correspondingly higher air velocities.

### SUMMARY OF INVENTION

It is an object of the present invention to at least substantially address one or more of the above-mentioned problems, or at least provide a useful alternative to the above discussed VTOL

In a first aspect the present invention provides a propulsion assembly for lifting a load, the propulsion assembly including:
a primary lift surface configured to, when rotating about a central axis, provide sufficient lift for lifting the load;
a secondary lift surface configured to provide lift along a second axis for lifting the propulsion assembly, wherein the second axis is configurable between a lifting configuration, wherein the secondary lift surface lifts the propulsion assembly, and a thrusting configuration, wherein the secondary lift surface induces rotation of the primary lift surface.

Preferably, the primary lift surface is movable between a stowed configuration and a deployed configuration, wherein a footprint of the primary lift surface is lower in the stowed configuration than in the deployed configuration.

Preferably, the primary lift surface is movable between the stowed and deployed configurations while being lifted by the secondary lift surface.

Preferably, the second axis of the secondary lift surface is continuously moveable between the lifting position and the thrusting position so that the proportion of lift of the secondary lift surface used to lift the propulsion assembly is continuously reduced as the lift produced by the primary lift surface increases with increasing rotational velocity of the primary lift surface about the central axis.

Preferably, the propulsion assembly further includes a lift surface control system to provide cyclic and collective control of the primary lift surface.

Preferably, the lift surface control system includes servo tabs.

Preferably, the propulsion assembly further includes a tether for connecting the propulsion assembly to the load, wherein the tether is adapted to transmit power from the load to the propulsion assembly for powering the propulsion assembly.

Preferably, the tether is retractable.

Preferably, the propulsion assembly further includes a first docking hub located at the central axis, the first docking hub being configured to engage the load when the tether is sufficiently retracted.

Preferably, the tether is connected to the propulsion assembly with a bearing to reduce torque applied by the tether to the propulsion assembly when tension is applied to the tether.

Preferably, the primary lift surface includes a rotor, preferably the rotor provides orientation control of the propulsion assembly.

Preferably, the secondary lift surface includes a rotor rotating about the second axis, preferably the rotor provides orientation control of the propulsion assembly.

Preferably, the propulsion assembly further includes an emergency power reserve to power the propulsion assembly for a powered descent.

Preferably, the secondary lift surface includes a plurality of secondary lifting surfaces.

Preferably, the tether includes an attachment interface to connect the tether to the propulsion assembly.

Preferably, the attachment interface is a non-flexible and non-rotating end point of the tether.

Preferably, the propulsion assembly includes a system for determining a spatial parameter of the propulsion assembly relative to the load.

Preferably, the spatial parameter includes an absolute orientation parameter and a relative orientation parameter of the propulsion assembly relative to the load.

Preferably, the system includes a magnetometer and/or a gyroscope to determine the spatial parameter.

Preferably, the system includes an encoder positioned between the propulsion assembly and attachment interface, to determine the spatial parameter.

Preferably, the attachment interface includes an aerodynamic surface and/or a thruster to control a heading of the tether.

Preferably, the tether includes a second attachment interface to connect the tether to the load to allow the propulsion assembly to fly at high angles with respect to the horizontal so as to allow for faster flight speeds.

Preferably, the second attachment interface includes an articulating frame that can change its orientation during flight to allow the load to stay level while the propulsion assembly tilts and to allow the propulsion assembly to fly at high angles of attack with respect to the horizontal and provide faster flight velocity.

Preferably, the load includes an aerodynamic surface capable of providing lift during horizontal flight.

In a second aspect the present invention provides a vertical take-off and landing aircraft including:
a body having a load-carrying cavity or area for the load;
the propulsion assembly of the first aspect to lift the body; and
a power generation assembly located in or on the body that is configured to power the propulsion assembly.

Preferably the aircraft further includes one or more directional thrusters attached to the body, the directional thrusters acting in a respective direction that is non-parallel to the central axis.

Preferably the aircraft further includes one or more directional thrusters attached to the body, the directional thrusters acting in a respective direction that is parallel to the central axis

Preferably, the directional thrusters include a ducted fan, a rotor, a jet thruster, and/or an impulse thruster.

Preferably, the body has a center of gravity and includes a winch for retracting the tether, wherein the uppermost point of control of the tether on the body is above the center of gravity of the body.

Preferably, the attachment interface has a center of gravity that is positioned above the center of gravity of the body and is spatially related to the center of gravity of the body to facilitate stable flight and control.

Preferably, the body further includes a second docking hub, the second docking hub being configured to engage the first docking hub when the tether is sufficiently retracted.

Preferably, the body further includes one or more control surfaces for setting a preferred orientation relative to a direction of travel and/or controlling an orientation of the aircraft relative to a direction of travel.

Preferably, the moveable surface is usable to assist in changing the direction of travel.

Preferably, the aircraft includes wheels located on the body and a motor to drive the wheels for propelling the aircraft on the ground.

### BRIEF DESCRIPTION OF DRAWINGS

Preferred embodiments of the present invention will now be described by way of example, with reference to the accompanying drawings, wherein:

FIG. 1 is a schematic front view of an aircraft with a propulsion assembly according to a preferred embodiment of the invention.

FIG. 2 is a schematic front view of the aircraft of FIG. 1 with the propulsion assembly in a stowed configuration.

FIG. 3 is a schematic front view of the aircraft of FIG. 1 with the propulsion assembly in a deployed configuration.

FIG. 4 is a schematic front view of the aircraft of FIG. 1 with the propulsion assembly commencing rotation of the primary lift surface.

FIG. 5 is a schematic front view of the aircraft of FIG. 1 with the propulsion assembly lifting the body.

FIG. 6 is a schematic front view of the aircraft of FIG. 1 demonstrating positional control of the directional thrusters.

FIG. 7 is a schematic front view of the aircraft of FIG. 1 with the body being retracted

FIG. 8 is a schematic front view of the aircraft of FIG. 1 with the body docked to the propulsion assembly in flight.

FIG. 9 shows a perspective view of an aircraft according to a second embodiment of the invention.

FIG. 10 shows the aircraft of FIG. 9 with the propulsion assembly docked.

FIG. 11 shows the aircraft of FIG. 9 with the propulsion assembly undocked and in the stowed configuration.

FIG. 12 shows the aircraft of FIG. 9 with the propulsion assembly moving toward the deployed configuration.

FIG. 13 shows the aircraft of FIG. 9 with the propulsion assembly in the deployed configuration.

FIG. 14 shows the aircraft of FIG. 9 with the propulsion assembly generating thrust with the primary lift surface, with the secondary lift surface generating thrust orthogonal to the primary lift surface.

### DETAILED DESCRIPTION

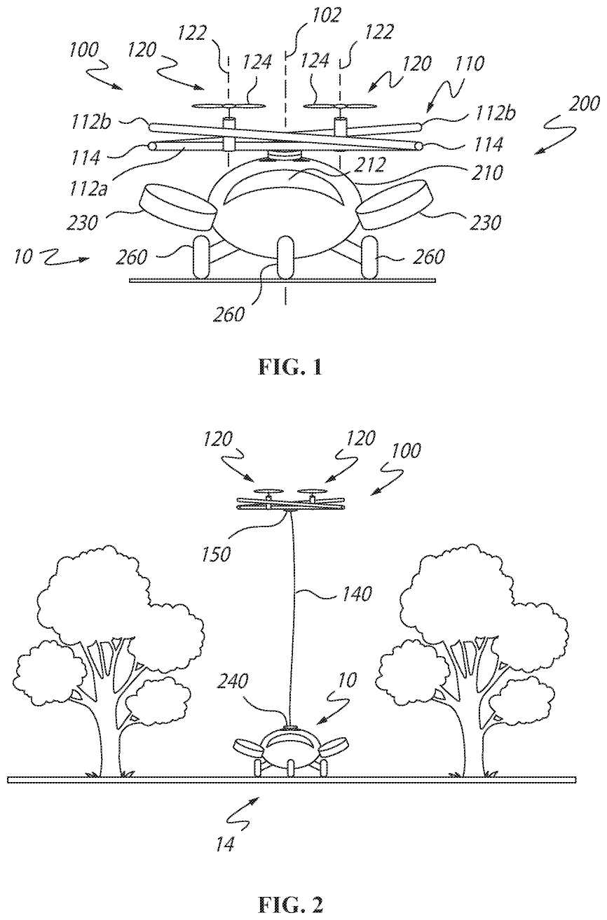

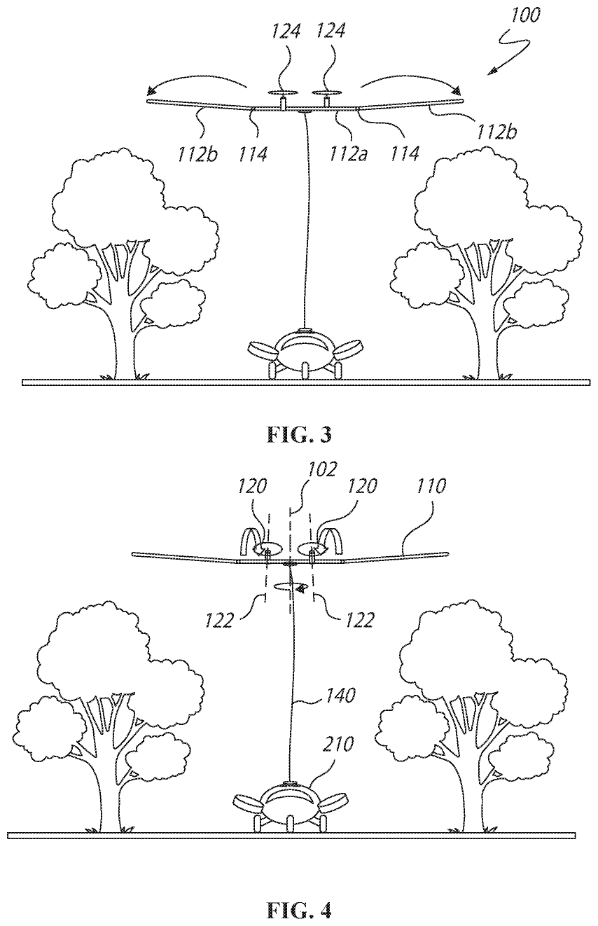

An aircraft 200, according to a preferred embodiment as shown in FIGS. 1 to 8, includes a propulsion assembly 100. The propulsion assembly 100 is adapted to lift a load 10 and configured to be powered by the load 10. As shown in FIG. 1, the propulsion assembly 100 includes a primary lift surface 110 configured to, when rotating about a central axis 102, provide sufficient lift for lifting the load 10. In a preferred embodiment, the primary lift surface 110 includes a large rotor blade 112 that is divided by joints 114 into a central section 112a and peripheral sections 112b that are hingeable relative to the central section 112a. In this way, the primary lift surface 110 is movable between a stowed configuration, having a smaller footprint as shown in FIG. 1, and a deployed configuration, having a larger footprint as shown in FIG. 3. Preferably, the movement of the primary lift surface 110 between the stowed and deployed configurations is effected by an actuator. As shown in these Figures, the footprint of the primary lift surface 110, as defined by a swept area of the primary lift surface 110 rotating about the central axis 102 on a plane normal to the central axis 102, is lower in the stowed configuration than in the deployed configuration. There are other approaches that could be taken to move the primary lift surface 110 between the stowed configuration and the deployed configuration. For example, the joints 114 may be arranged in a concertina, or a telescoping prismatic joint. The joints 114 may include vertical, horizontal, or diagonal pivots, comprise bearings (not shown), hinges (not shown), locking mechanisms (not shown), and/or actuators (not shown). There could be a plurality of joints 114. In the deployed configuration, the radius of the primary lift surface 110 is in the range of 5 m to 12 m, more preferably about 8.25 m. In the stowed configuration, the primary lift surface 110 has a radius of less than 3 m, preferably about 2.5 m. In another embodiment, the primary lift surface 110 has a radius of in excess of 12 m in the deployed configuration to provide a sky crane. In yet another embodiment, the primary lift surface 110 has a radius below 5 m in the deployed configuration to provide a lower-load version of the aircraft 100.

Moving back to FIG. 1, the propulsion assembly 100 further includes a secondary lift surface 120 configured to, when rotating about a second axis 122, provide sufficient lift for lifting the propulsion assembly 100, and/or provide a force moment to rotate the propulsion assembly 100. Preferably, the secondary lift surfaces 120 are located at a distance from the central section 112a of the primary lift surface 110, so that a moment is created by the thrust generated by the secondary lift surfaces 120. In another embodiment, the secondary lift surface 120 is located on the central section 112a and configured to create a moment about the central axis 102. Most preferably, the secondary lift surfaces 120 are located at an extremity of the primary lift surface 110 as blade-tip thrusters. In one embodiment the secondary lift surfaces 120 are located at the extremity of the primary lift surface 110 when the primary lift surface is in the stowed configuration. In another embodiment, the secondary lift surface 120 are located at the extremity of the primary lift surface 110 when the primary lift surface in the deployed configuration. Preferably, the secondary lift surfaces 120 are driven by at least one motor (or a plurality of motors) to achieve sufficient lift to the load 10 off the ground. The motor may include a thruster. Preferably, the motor, or the plurality of motors combined, has a total electrical peak power of 50 kW to 150 kW, more preferably 80 kW to 85 KW, and a total electrical continuous power of 50 kW to about 70 KW, preferably about 55 kW. In the preferred embodiment, the secondary lift surface 120 includes one or more small rotors 124 rotating about a respective second axis 122. The second axis 122 of the at least one small rotor 124, or plurality of small rotors 124, is adjustable, preferably continuously adjustable, to control the direction of lift generated by the secondary lift surface 120. If the second axis 122 is adjusted to be non-parallel to the central axis 102, the lift of the secondary lift surface 120 induces a rotation of the primary lift surface 110 about the central axis 102. In other embodiments, the lift surfaces 110, 120 may be positioned such that it is not required for the second axis 122 to be non-parallel to the first axis 102. By adjusting, preferably continuously, the direction of the second axis 122, the proportion of lift of the secondary lift surface 120 used to lift the propulsion assembly 100 may be reduced or increased, and the proportion of lift of the secondary lift surface 120 used to induce a rotation of the primary lift surface 110 about the central axis 102 may be correspondingly increased or reduced. Thus, the thrust generated by the secondary lift surface 120 in the direction of the second axis 122 is usable to control lift and orientation of the propulsion assembly 100 by controlling moment induction using the direction of the second axis 202 and the quantum of thrust produced by the secondary lift surface 120. Preferably, the secondary lift surface 120 is configured to operate at peak efficiency when inducing rotation of the primary lift surface 110 for lifting the load 20, as this is the most-used operational envelope for the secondary lift surface 120. In other preferred embodiments, the secondary lift surface 120 includes a jet thruster, a ram jet, or an impulse device, such as a rocket. In some embodiments, the secondary lift surface 120 need not necessarily rotate about a second axis 122 but provides thrust along the second axis 122. Preferably, the thrust of the secondary lift surface 120 may be increased beyond the design thrust by a performance margin for a finite period of preferably about 300 s. Preferably the performance margin is up to 30%. As shown in FIG. 3, the primary lift surface 110 may be moved between the stowed and deployed configurations while being lifted by the secondary lift surface 120.

The propulsion assembly 100 may further include a lift surface control system (not shown) including servo tabs (not shown), as for example embodied on the Kaman K-MAX helicopter, to provide cyclic and collective control of the primary lift surface 110. In other embodiments the lift surface control system may include blade pitch pivots. This, in addition with control over the rotational speed of the primary lift surface 110, allows the position of the primary lift surface 110 to be controlled.

As shown in FIG. 2, the propulsion assembly 100 may further include a tether 140 for connecting the propulsion assembly 200 to the load 10. The tether 140 is preferably connected to the propulsion assembly 100 using a bearing (not shown), such as a gimbal, pivot bearing, or other device adapted to prevent tension applied to the tether 140 from inducing a torque in the propulsion assembly 100. Preferably, the bearing is located proximate or collocated with a centre of mass of the propulsion assembly 100 when the primary lift surface 110 is in the deployed configuration and provides the lift to lift the propulsion assembly 100 from rotation induced by the secondary lift surface 120. The tether 140 is adapted to transmit power from the load 10 to the propulsion assembly 100 for powering the propulsion assembly 200, for example by inclusion of an electrical power line carrying electrical power in the form of low voltage, alternating current, and/or high voltage direct current. The tether 140 is also adapted to transmit control signals from the load 10 to the propulsion assembly 100, though the propulsion assembly 100 may also include a backup flight computer, flight sensors, and a telecommunications system for independent control, if required. For example, the tether 140 may include a separate data cable for transmitting control signals. Preferably, the tether 140 is retractable. The propulsion assembly 100 may further include a first docking hub 150, preferably located at the central axis 102. The first docking hub 150 is configured to engage the load 10 when the tether 140 is sufficiently retracted, preferably to secure the load during operation of the propulsion assembly 100 in cruise or when on the ground.

The propulsion assembly 100 may further include an emergency power reserve (not shown) to power the propulsion assembly 100 for a powered descent. In one embodiment, the emergency power reserve is sized so that sufficient power is available for a time period corresponding to a powered descent of the propulsion assembly 100 with the load 10 from the maximum design cruise altitude, noting that a portion of that descent may be unpowered under autorotation of the primary lift surface 110. In another embodiment, the emergency power reserve is sized so that sufficient power is available for a time period corresponding to a powered descent of only the propulsion assembly 100 (without the load 10) from an altitude corresponding to a length of the tether 140. In one embodiment, the power transmitted from the tether 140 is fed to the emergency power reserve, which then powers the secondary lift surfaces 120. Thus, the propulsion assembly 100 may be indirectly powered by the tether 140.

Returning to FIG. 1, the aircraft 200 is preferably a vertical take-off and landing (VTOL) aircraft and includes a body 210 having a load-carrying cavity or area 212. The body 210 may further include access doors (not shown), cargo apertures (not shown), and/or windows (not shown). The body 210 may further includes cushioning (not shown), damping (not shown), and/or suspension (not shown) to reduce the impact experienced by the body 210 on landing. In another embodiment a cradle (not shown) may be provided to receive the aircraft 200 on landing. In one embodiment, the cradle may include a refueling or recharging station to replenish an energy source of the aircraft 200. The body 210 may include wheels 260 to allow the aircraft 200 to be moved when landed. In one embodiment, the wheels 260 may include a motor (not shown), such as an electrical motor, for example a hub motor, to propel the aircraft 200 as a vehicle on the ground, preferably for limited distances such as moving from the target landing site 14 to a storage area (not shown) for the aircraft 200. In one embodiment, the wheels 260 may be retractable to improve the aerodynamic efficiency of the aircraft 200 during cruise conditions. In another embodiment, the wheels 260 may include fixed wheels to reduce weight and mechanical complexity. In one embodiment, the wheels may include one or more of a skid, a ski, and a pontoon. In one embodiment, the cradle could be provided with the wheels 260 to propel the aircraft as a vehicle on the ground. In one embodiment, the movement of cradle using the wheels 260 may be remotely operated. For the purposes of the discussion above, the body 210, inclusive of any contents or attached payload, can be considered as the load 10. The aircraft 200 includes the propulsion assembly 100 as described above, as well as a power generation assembly (not shown) configured to power the propulsion assembly 200. When landed, the aircraft 200 may be connected to ground power or an external power generation assembly. The power generation assembly may include batteries, fuel cells, supercapacitors, and/or generator power. Preferably, the generator power is provided by an internal combustion engine, such as a Wankel engine. Preferably, the aircraft includes supercapacitors in order to provide a high current for a short time, which would degrade a Li-Ion battery, or require oversizing of the generator. The aircraft 200 may also include one or more directional thrusters 230 mounted on the body 210. Each directional thruster 230 acts in a respective thruster direction 232 that is preferably non-parallel to the central axis 102. In one embodiment, the thruster direction 232 is adjustable. In a preferred embodiment, the directional thrusters 230 include a ducted fan. In other embodiments, the directional thrusters 230 include a rotor, a jet thruster, and/or an impulse thruster such as a cold gas thruster, hypergolic or other chemical impulse systems. The directional thrusters 230 may be used when the load 10 is suspended from the propulsion assembly 200 to maneuver the load relative to the propulsion assembly in roll, pitch, yaw, and/or translation motions. For example, the directional thruster 230 could be mounted on a side of the aircraft 200 to reorient the load 10 like the tail rotor of a helicopter. The directional thrusters 230 may be aligned vertically, in a multi-copter configuration, or non-parallel to gravity, or some combination. The directional thrusters 230 may be parallel to the central axis 112, or non-parallel to the central axis 112. In a preferred embodiment, the directional thrusters 230 include three pairs of parallel opposite thrusters that are aligned orthogonal to each other so that the combination of thrust forces and torque couples allow full motion in longitudinal, lateral, roll, pitch and yaw directions. In one embodiment, the directional thruster 230 may include a tail rotor (not shown) mounted to the aircraft 200. In one embodiment, the load 10 may include an aerodynamic surface capable of providing lift during horizontal flight, such as a wing, a tailplane, canard or the like.

The aircraft 200 may include cameras (not shown) to identify a target landing site 14. The aircraft 200 may include a controller (not shown) operating a control system configured to detect the target landing site 14 using one or more of a specified marker, geometric shape, colour, a landing light, an apron colour, or an “H” letter. The aircraft 200 may further include one or more of LIDAR sensors (not shown), ultrasound range-finders to, in addition or in place of the use of the cameras, detect obstacles surrounding the target landing site 14. The aircraft 200 may engage an instrument landing system (ILS) to land the aircraft 200. The aircraft 200 may include altitude and/or airspeed sensors (not shown) in the propulsion assembly 100 and/or the body 210 for use by the control system, in addition to or in place of one or more of the LIDAR sensors, ultrasound range-finders, cameras, and a radar (not shown) to regulate altitude and airspeed.

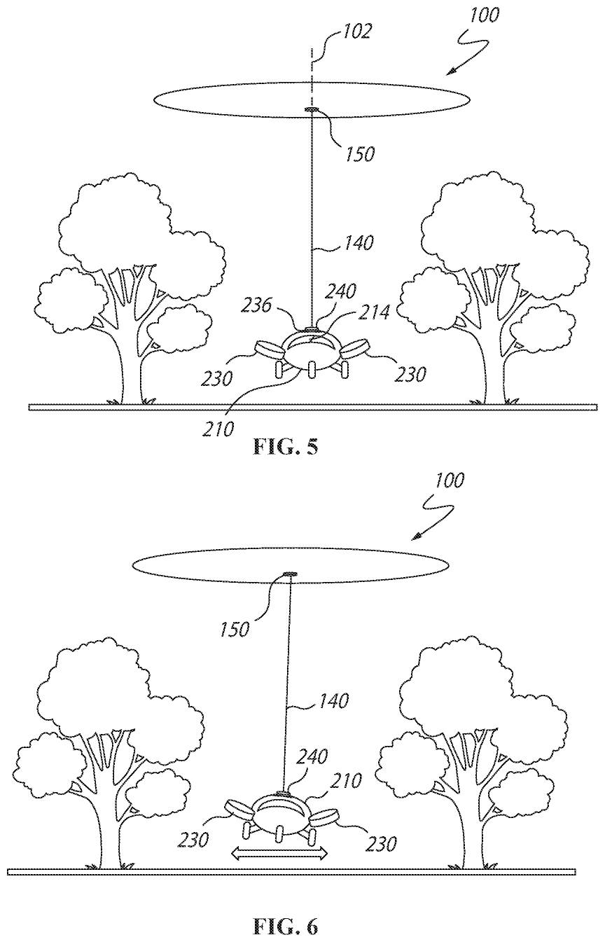

As shown in FIG. 5, the body 210 has a center of gravity 214 and may further include a winch (not shown), preferably an electrically powered capstan. The winch preferably includes a locking mechanism (not shown) to prevent uncontrolled release of the tether 140. The winch may also include an emergency mechanism (not shown) to sever or release the tether 140. The aircraft 200 may further include a safety mechanism (not shown) for the load 20 when released by the emergency mechanism. The body 210, winch, and tether 140 are configured such that an uppermost point of control 236 of the tether 140 on the body 210 is located above the center of gravity 214, so that the body 210 is suspendable in a stable position under the propulsion assembly 100. The body 210 may further include a second docking hub 240, preferably located at the central axis 102. The second docking hub 240 is configured to engage the first docking hub 150 when the tether 140 is sufficiently retracted. The engagement between the first docking hub 150 and the second docking hub 240 may leave a number of degrees of freedom between the first docking hub 150 and the second docking hub 240. For example the first docking hub 150 may include a dome with the second docking hub 240 having a conforming dome-shaped recess.

The body 210 may further include one or more control surfaces (not shown), such as a rudder or an empennage or a tear drop shape, to set a preferred orientation of the body 210 during flight by creating a corrective force towards the preferred orientation when travelling in a direction of travel 12, shown in FIG. 8. The one or more control surfaces may also be usable to assist in changing and/or controlling the direction of travel 12, by creating a drag and/or lift force that is non-parallel with the direction of travel 12.

The body 210 may further include a ballistic parachute (not shown) to be used in emergencies. In an emergency, the propulsion assembly 100 may be used to attempt an autorotation landing or be disconnected from the body 210 for the body to land under the ballistic parachute, with the propulsion assembly 100 optionally attempting a powered or unpowered landing, or deploying a separate ballistic parachute (not shown), or other impact dampening mechanism, for example a deployable gas bag or crumple zone. If the emergency occurs at higher altitudes, an autorotation descent may be performed first, with the above actions being taken closer to ground level.

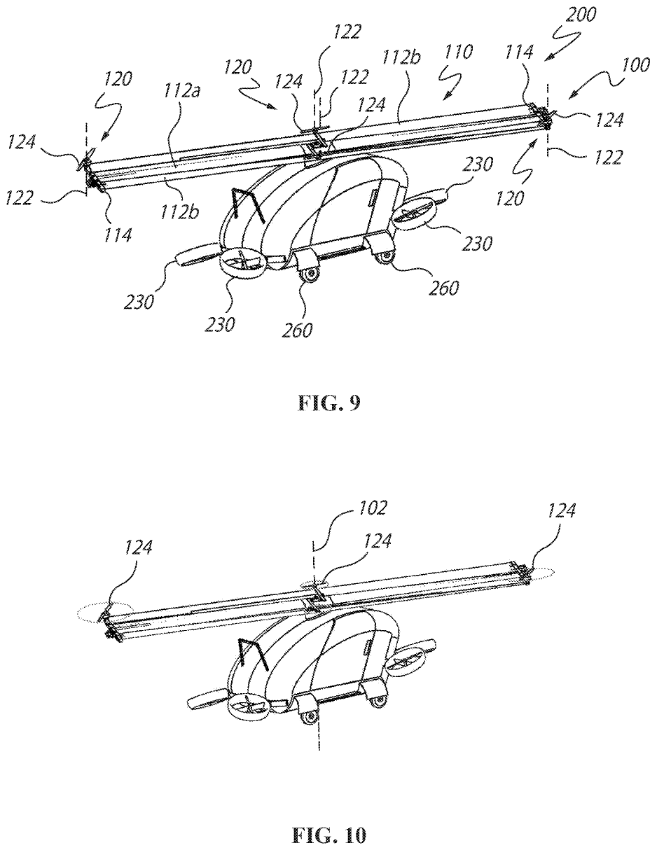

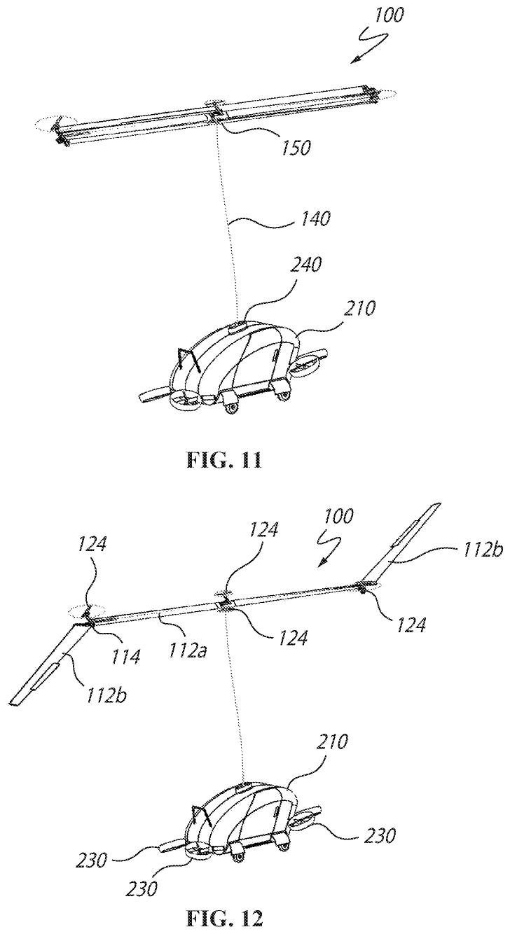

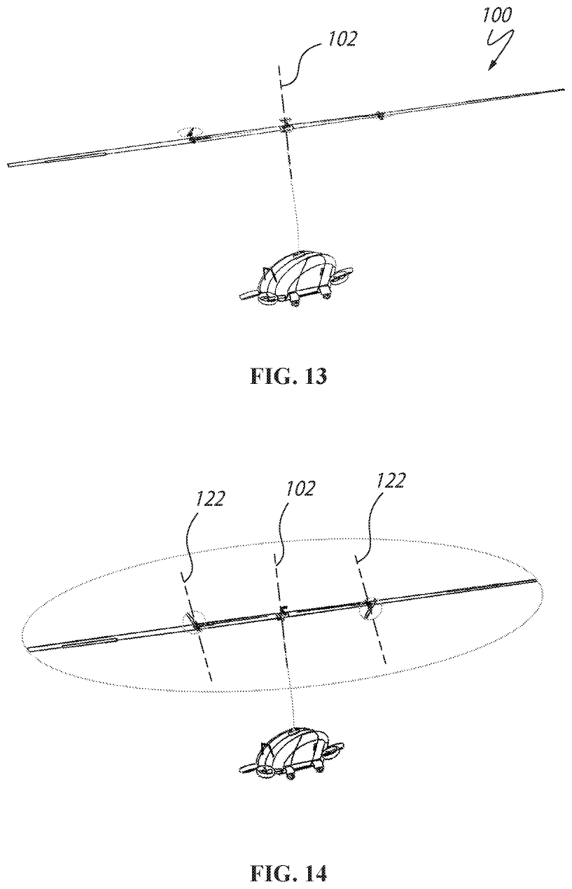

FIGS. 9 to 14 show a second embodiment of the aircraft 200 and propulsion assembly 100, showcasing some of the embodiments previously discussed.

Use of various embodiments of the VTOL aircraft 200 with the propulsion assembly 100 will now be discussed.

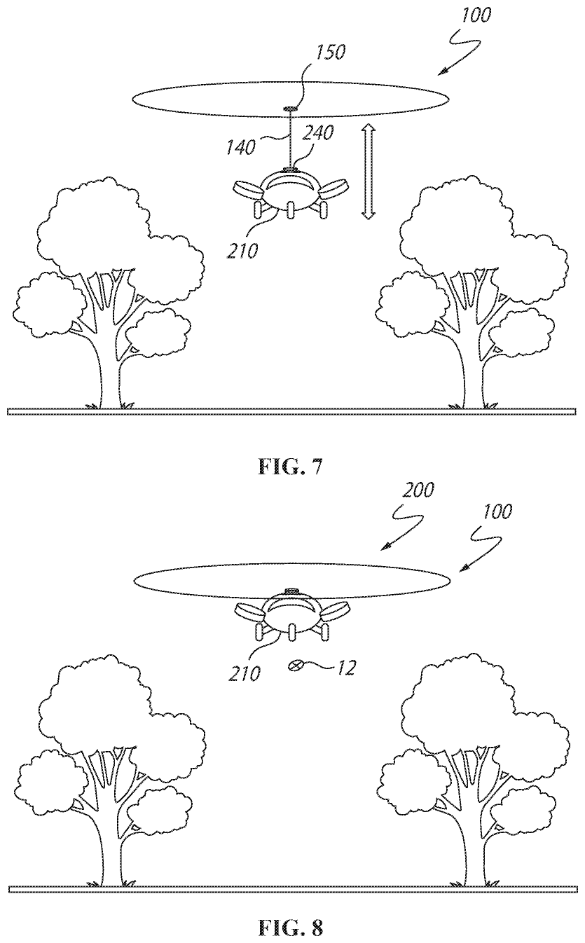

The VTOL aircraft 200 at rest is shown in FIG. 1. In order to take off, the docking hubs, if used and/or required, 150, 240 disconnect and the propulsion assembly 100 is lifted upwards using lift produced by the secondary lift surfaces 120 rotating about the second axis 122, as shown in FIG. 2. If multiple secondary lift surfaces 120 are used, differential thrust between them may be used for pitch and/or attitude control. At a height that may be predetermined, commanded, or assessed to be safe based on sensor input, the primary lift surface 110 is moved from the stowed configuration to the deployed configuration by hinging of the peripheral sections 112b about the joints 114, as shown in FIG. 3. Once the primary lift surface 110 is in the deployed configuration, the second axes 122 are rotated so as to produce a moment arm about the central axis 102, such that the lift produced by the secondary lift surfaces 120 induces a rotation in the primary lift surface 110. The rotation or movement of the second axis 122 may be performed as an actual rotation of the secondary lift surface 120, or a change in contribution to the lift by a plurality of differently oriented secondary lift surfaces 120 such that the resultant lift vector changes direction. As the rotational speed of the primary lift surface 110 increases, increasing lift is produced by the primary lift surface 110, allowing the second axes 122 to be rotated further so that a smaller proportion of the lift produced by the secondary lift surfaces 120 is used to lift the propulsion assembly 200 and a larger proportion is used to induce rotation of the primary lift surface 110. Once the lift produced by the primary lift surface 110 exceeds the weight of the aircraft 200, the body 210 lifts off, as shown in FIG. 5. In another embodiment, the body 210 is lifted by actuation of the winch. While the body 210 is suspended below the propulsion assembly 100 on the tether 140, the body 210 may require positional and/or orientational control, which is provided in combination or selection by the directional thrusters 230 and the lift surface control system 130 of the propulsion assembly 100, as shown in FIG. 6. The tether 140 may be retracted using the winch so that a distance between the body 210 and the propulsion assembly 100 is reduced, leading to a lower range of motion of the body 210, as shown in FIG. 7. Preferably, the tether 140 is sufficiently retracted so that the docking hubs 240, 150 engage to connect the body 210 to the propulsion assembly 100, however in other embodiments the load 10 or body 210 may remain suspended below the propulsion assembly 100. The aircraft 200 is now flyable as a helicopter, in other embodiments the aircraft 200 is flyable as a helicopter with a slung load, preferably at cruising speeds preferably exceeding 200 km h⁻¹, more preferably up to 300 km h⁻¹, and a cruising range between 300 km to 500 km, with an endurance of about 2 h, carrying a load 10 with a weight between 200 to 420 kg, with a noise level between 105 dBA to 115 dBA.

The above-described steps may be performed in reverse-order to land the aircraft 200. If the target landing site 14 is sufficiently unrestricted, the aircraft 200 may land without extending the tether 140 and/or uncoupling the propulsion assembly 100.

Advantages of various embodiments of the aircraft 200 will now be discussed.

Because the footprint of the primary lift surface 110 is lower in the stowed configuration, the propulsion assembly 100 may lift off at ground level with a relatively small clearance provided, and deploy the primary lift surface 110 required to lift the aircraft 200 at an altitude safe of obstruction, and reducing downwash and noise experienced at ground level. The primary lift surface 110 may be substantially larger in the deployed configuration than that of a helicopter, since the only limiting factor is the stowed footprint of the primary lift surface. Additionally, the smaller foot print results in a much lower rotor droop, improving ground clearance requirements and reducing rotor ground strike probabilities.

The use of the secondary lift surface 120 to both lift the propulsion assembly 100, and induce rotation of the primary lift surface 110 desirably reduces the number of components and systems required in the propulsion assembly 100, reducing weight and complexity. The gradual control of the direction of the second axis 122 allows a smooth transition of the secondary lift surface 120 between the task of lifting the propulsion assembly 100 and powering the primary lift surface 110. The use of the lift surface control system 130 allows orientational and positional control of the propulsion assembly 100 without a plurality of primary lift surfaces 110 providing differential thrust, such as a quadcopter layout. The use of rotors for the primary and secondary lift surfaces 110, 120 is desirable for the planned route lengths for the aircraft 200. Because the primary lift surface 110 is driven by the secondary lift surface 120, which is effectively an impulse transfer device from the surrounding air to the primary lift surface 110, the opposing force for driving the primary lift surface 110 does not travel through to the hub 150 but is exerted on the surrounding air. As a result, there is virtually no need for a tail rotor that is required on a directly driven primary rotor. The use of multiple secondary lift surfaces 120 allows the impulse of those surfaces to cancel each other by being driven in opposite directions, and any remaining torque that is created due to imperfect balance, or the friction in various bearings, could be addressed using the directional thrusters 230.

The use of the tether 140 to transmit power from the body 210 to the propulsion system 100 reduces duplication of power systems and allows the propulsion system 100 to have a very low weight, such that it is liftable by the secondary lift surface 120, and preferably only carry the emergency power reserve 160 in case the connection between the body 210 and the propulsion system 100 is compromised. The retractability of the tether 140 allows for the body 210 and the propulsion system 100 to be reconnected, increasing the stability of the aircraft 200. The use of the docking hubs 240, 150 aids in disconnecting and reconnecting the body 210 and the propulsion system 100.

The use of directional thrusters 230 allows positional control of the body 210 while it is suspended by the tether 140. In flight, the directional thrusters 230 may also be used for steering the aircraft 200. The use of ducted fans for the directional thrusters 230 increases the safety of the directional thrusters 230, and increases aerodynamic efficiency for the design performance envelope of the directional thrusters 230. The directional thrusters 230 may be used instead of a tail rotor to counteract undesirable torque acting on the aircraft 200.

A major limitation of helicopters is that their construction limits their maximum speed due to reverse flow across retreating blades in horizontal flight. Tilt-rotor rotorcraft avoid this by allowing their rotors to angle forward to the horizontal so that oncoming air approaches parallel to the rotor axis. Presently, this technique is adapted and extended to the tethered propulsion assembly by adding the capability for the tethered propulsion assembly to be tilted and displaced downward until the tethered assembly leads the load, drawing it along like a tug. The direction of travel and thus air entering the propulsion assembly will therefore largely align with the axis of rotation of the propulsion assembly.

To enable this, the load is preferentially equipped with a pivoting tether mount so that the propulsion assembly can change its angle under tether tension while the load remains level. The pivoting mount requires a tether linkage point and an articulation point, preferably axially aligned with the centre of mass, and may include a tether force sensor, locking mechanism or actuator. The propulsion assembly r is preferentially equipped with a mechanism for feathering the propulsion assembly's primary lifting surfaces to attain the appropriate angle of attack with respect to the oncoming wind.

During rotating flight, the propulsion assembly has no fixed heading relative to the load. The aerodynamic surfaces of the propulsion assembly apply control inputs in a continuously rotating frame of reference, which requires modulation with respect to any absolute desired heading to maintain effective control. Helicopters solve this problem using cyclic control, in which the rotor pitch inputs are indexed against a reference angle applied to the swashplate. As the tether is unable to apply torques along the axis of rotation, a different approach must be used.

In a preferred embodiment, the tether 140 may include an attachment interface to connect the tether to the propulsion assembly 100. The attachment interface can be a non-flexible and non-rotating end point of the tether 140. The attachment interface may be co-located within the docking hub 150. Alternatively, the attachment interface may be located outside of the docking hub 150 on the propulsion assembly 100. It will be appreciated by those skilled in the art that the tether 140 needs to rotate at the attachment interface (i.e. at the connection to the propulsion assembly 100) to prevent coiling of the tether 140. Further, the attachment interface has a center of gravity that is positioned above the center of gravity of the body 210 and is spatially related to the center of gravity of the body 210 to facilitate stable flight and control.

A system is also provided to determine a spatial parameter of the propulsion assembly 100 relative to the load 10. The spatial parameter includes an absolute orientation parameter and a relative orientation parameter of the propulsion assembly 100 relative to the load 10. To determine the spatial parameter, the system may include a magnetometer and/or a gyroscope. Additionally, the system may include an encoder (such as, for example a Hall effector sensor or similar absolute orientation sensor) positioned between the propulsion assembly 100 and the attachment interface, to determine the spatial parameter.

A combination of inertial or magnetic reference systems are used to determine the heading of the load 10 and the heading of the propulsion assembly 100, and thus calculate the relative orientations so that correct control inputs can be computed to provide the desired trajectory in flight. As constant rapid rotation can make inertial and magnetic system measurements unreliable, a heading reference system may be provided on the attachment interface which is connected to the tether 140. The encoder can determine the orientation of the propulsion assembly with respect to the attachment interface, and as stated above, is provided between the attachment interface and the propulsion assembly. The attachment interface may be optionally stabilised with an aerodynamic surface such as a tail, control surface or thruster in order to maintain a desired heading with respect to the load.

The tether 140 may include a second attachment interface at the opposite end of the tether 140 to connect the tether 140 to the load 10. The second attachment interface may be co-located within the hub 240 or position outside of the hub 240 on the load 10. The second attachment interface may include an articulating frame that may change its orientation during flight to allow the load 10 to remain level while the propulsion assembly 100 tilts. The articulating frame also allows the propulsion assembly to fly at high angles of attack with respect to the horizontal and provide faster flight velocity.

Using a computer or similar system, the relative rotation between the propulsion assembly and the attachment interface is computed, and from this the orientation with respect to the load 10 and the surrounding environment may then be computed. Thus, for any given orientation of propulsion assembly 100, attachment interface and load 10, appropriate control signals may be computed to maneuver the propulsion assembly 100 in the desired direction.

1-35. (canceled)

36. A propulsion assembly for lifting a load, the propulsion assembly including:
a primary lift surface configured to, when rotating about a central axis, provide sufficient lift for lifting the load;
a secondary lift surface configured to provide lift along a second axis for lifting the propulsion assembly, wherein the second axis is configurable between a lifting configuration, wherein the secondary lift surface lifts the propulsion assembly, and a thrusting configuration, wherein the secondary lift surface induces rotation of the primary lift surface.

37. The propulsion assembly of claim 36, wherein the primary lift surface is movable between a stowed configuration and a deployed configuration, wherein a footprint of the primary lift surface is lower in the stowed configuration than in the deployed configuration.

38. The propulsion assembly of claim 36, wherein the primary lift surface is movable between the stowed and deployed configurations while being lifted by the secondary lift surface.

39. The propulsion assembly of claim 36, wherein the second axis of the secondary lift surface is continuously moveable between the lifting position and the thrusting position so that the proportion of lift of the secondary lift surface used to lift the propulsion assembly is continuously reduced as the lift produced by the primary lift surface increases with increasing rotational velocity of the primary lift surface about the central axis.

40. The propulsion assembly of claim 36, wherein the propulsion assembly further includes a lift surface control system to provide cyclic and collective control of the primary lift surface and wherein the lift surface control system includes servo tabs.

41. The propulsion assembly of claim 36, wherein the propulsion assembly further includes a tether for connecting the propulsion assembly to the load, wherein the tether is adapted to transmit power from the load to the propulsion assembly and wherein the tether is retractable.

42. The propulsion assembly of claim 41, wherein the propulsion assembly further includes a first docking hub located at the central axis, the first docking hub being configured to engage the load when the tether is sufficiently retracted and/or wherein the tether is connected to the propulsion assembly with a bearing to reduce torque applied by the tether to the propulsion assembly when tension is applied to the tether.

43. The propulsion assembly of claim 36, wherein the primary lift surface includes a rotor.

44. The propulsion assembly of claim 36, wherein the secondary lift surface includes a rotor rotating about the second axis.

45. The propulsion assembly of claim 36, wherein the secondary lift surface includes a plurality of secondary lifting surfaces.

46. The propulsion assembly of claim 45, wherein the tether includes an attachment interface to connect the tether to the propulsion assembly and the attachment interface is a non-flexible and non-rotating end point of the tether and including a system for determining a spatial parameter of the propulsion assembly relative to the load.

47. The propulsion assembly of claim 46, wherein the spatial parameter includes an absolute orientation parameter and a relative orientation parameter of the propulsion assembly relative to the load and wherein the system includes a magnetometer and/or a gyroscope to determine the spatial parameter.

48. The propulsion assembly of claim 47, wherein the system includes an encoder positioned between the propulsion assembly and attachment interface, to determine the spatial parameter.

49. The propulsion assembly of claim 48, wherein the attachment interface includes an aerodynamic surface and/or a thruster to control a heading of the tether and wherein the tether includes a second attachment interface to connect the tether to the load to allow the propulsion assembly to fly at high angles with respect to the horizontal so as to allow for faster flight speeds.

50. The propulsion assembly of claim 49, wherein the second attachment interface includes an articulating frame that can change its orientation during flight to allow the load to stay level while the propulsion assembly tilts and to allow the propulsion assembly to fly at high angles of attack with respect to the horizontal and provide faster flight velocity.

51. A vertical take-off and landing aircraft including:
a body having a load-carrying cavity or area for the load;
a propulsion assembly for lifting a load, the propulsion assembly including,
a primary lift surface configured to, when rotating about a central axis, provide sufficient lift for lifting the load, and
a secondary lift surface configured to provide lift along a second axis for lifting the propulsion assembly, wherein the second axis is configurable between a lifting configuration, wherein the secondary lift surface lifts the propulsion assembly, and a thrusting configuration, wherein the secondary lift surface induces rotation of the primary lift surface; and
a power generation assembly located in or on the body that is configured to power the propulsion assembly.

52. The aircraft of claim 51, further including one or more directional thrusters attached to the body, the directional thrusters acting in a respective direction that is non-parallel or parallel to the central axis.

53. The aircraft of claim 52, wherein the directional thrusters include a ducted fan, a rotor, a jet thruster, and/or an impulse thruster.

54. The aircraft of claim 51, wherein the body further includes one or more control surfaces for setting a preferred orientation relative to a direction of travel and/or controlling an orientation of the aircraft relative to a direction of travel wherein the moveable surface is usable to assist in changing the direction of travel.

55. The aircraft of claim 51, wherein the aircraft includes wheels located on the body and a motor to drive the wheels for propelling the aircraft on the ground.
